(19) United States
(12) Patent Application Publication
(10) Pub. No.: US 2025/0042050 A1
(43) Pub. Date: Feb. 6, 2025

(54) RELEASABLE ELECTRIC CONNECTION IN A HANDHELD PERSONAL CARE DEVICE

(71) Applicant: KONINKLIJKE PHILIPS N.V., EINDHOVEN (NL)

(72) Inventors: MARCUS CORNELIS PETRELLI, GRONINGEN (NL); JEROEN CHRISTIAN NIJDAM, EELDERWOLDE (NL); MARC ALEXANDER PASTOORS, GIETEN (NL)

(21) Appl. No.: 18/718,401

(22) PCT Filed: Dec. 1, 2022
(86) PCT No.: PCT/EP2022/083975

§ 371 Date: Jun. 10, 2024

(30) Foreign Application Priority Data
Dec. 14, 2021 (EP) 21214325.9

(51) Int. Cl. B26B 19/38; B26B 19/14; B26B 19/28; B26B 19/46

(52) U.S. Cl. CPC B26B 19/386; B26B 19/14; B26B 19/28; B26B 19/3873; B26B 19/46

(57) ABSTRACT

In a handheld personal care device, one of a main unit and a functional attachment of the device comprises a first coupling member (1) having a first coupling axis (C₁), and a first electrical contact element (41) electrically connected to an electrical component of said one of the main unit and the functional attachment, and the other one of the main unit and the functional attachment comprises a second coupling member (2) having a second coupling axis (C₂), and a second electrical contact element (61) electrically connected to an electrical component of said other one of the main unit and the functional attachment. The first electrical contact element (41) comprises a metal spring element (12) and the second electrical contact element (61) is provided on or comprised by a surface of the second coupling member (2) which is configured to be engaged by the spring element (12).

### FIELD OF THE INVENTION

The invention relates to a handheld personal care device comprising a main unit and a functional attachment couplable to and decouplable from the main unit and having a functional personal care unit, wherein:
one of the main unit and the functional attachment comprises a first coupling member having a first coupling axis, a receiving chamber and a metal spring element arranged in the receiving chamber;
the other one of the main unit and the functional attachment comprises a second coupling member having a second coupling axis and a coupling element provided with an engagement surface extending obliquely relative to the second coupling axis;
the first and second coupling members are mutually couplable by aligning the first and second coupling axes and moving the first and second coupling members towards each other along the aligned first and second coupling axes into a coupled condition;
the first and second coupling members are mutually decouplable from the coupled condition by exerting a decoupling force greater than a predefined threshold force on one of the first and second coupling members in an axial direction parallel to the aligned first and second coupling axes and away from the other one of the first and second coupling members;
the receiving chamber is configured and arranged to receive the coupling element in the coupled condition of the first and second coupling members; and
the spring element is configured and arranged to engage with the engagement surface under influence of a spring force of the spring element in said coupled condition of the first and second coupling members to provide a retaining force being substantially the sole force that retains the functional attachment coupled to the main unit in a direction parallel to the axial direction.

### BACKGROUND OF THE INVENTION

WO 2008/062339 A1 discloses a shaving device which comprises a head structure and a base structure. The head structure is configured to support at least one shaving head. The head structure is releasably retainable on the base structure. The base structure is free of support elements in an area of an outer circumference of the head structure such that the head structure, when coupled to the base structure, is not supported in the area of its outer circumference. The head structure, when coupled to the base structure, is substantially only retained on the base structure by a retaining force provided by a retaining structure of the base structure.

The head structure comprises a coupling element arranged in a central area of the head structure. In an embodiment of the known shaving device, the coupling element is a shaft-like element protruding from the central area of the head structure and comprising at its distal end a sloped surface facing a support structure of the head structure which serves to support the at least one shaving head, and the retaining structure comprises a retaining recess for receiving the coupling element, and a spring element at least partly provided in the retaining recess, wherein the spring element is arranged for engaging the sloped surface of the coupling element such that the coupling element is retainable in the retaining recess. The spring element is capable of clamping the coupling element by engaging the sloped surface. For releasing the coupling element, the spring element has to be forced to shift over the sloped surface by a large load, in particular a torque. If the load is sufficiently large, the spring element shifts off the sloped surface, thereby releasing the coupling element. The sloped surface may be provided either as a protrusion from the shaft-like element or in a coupling recess in the shaft-like element.

When an external load is exerted on the head structure of the known shaving device, the load is transferred to the coupling element. Since in the coupled state the head structure is not supported in the area of its outer circumference, the area of the outer circumference cannot contribute in transferring the external load to the base structure. As a result, the coupling element has to transfer a substantial part of the external load. Since in addition the coupling element is arranged in the central area of the head structure, the mechanical torque associated with the external load will lead to a relatively high force on the coupling element. If the external load is large enough, the coupling element is released from the retaining structure, thereby preventing that an overload would result in damage to the at least one shaving head or the head structure.

WO 2021/013608 A1 discloses another example of a shaving device comprising a base structure and a head structure which is releasably retainable on the base structure, wherein the head structure comprises a shaft-like coupling element protruding from a central area of the head structure, and wherein the base structure comprises a retaining structure including a retaining recess for receiving the coupling element, and a spring element at least partly provided in the retaining recess. The coupling element and the retaining structure are designed such that when a user of the shaving device desires to decouple the head structure from the base structure, he/she is supposed to do so by exerting forces on the head structure and the base structure aimed at pulling the head structure and the base structure apart, while at the same time the user is allowed to twist the head structure and the base structure with respect to each other to thereby facilitate decoupling the coupling element from the retaining structure.

It is an object of the invention to provide a handheld personal care device comprising a main unit and a functional attachment couplable to and decouplable from the main unit and having a functional personal care unit, such as the shaving device known from WO 2008/062339 A1 or the shaving device known from WO 2021/013608 A1, and to equip the device with a mechanism for establishing an electric connection between the main unit and the functional attachment when the device is in the coupled state. For example, it may be practical to have one or more electric power consuming members in the functional attachment, and to have a power source in the main unit for powering those one or more electric power consuming members. In the context of shaving devices, examples of electric power consuming members as may be used in the functional attachment, particularly the functional personal care unit of the functional attachment, include LEDs for providing a skin benefit during the shaving process, and various types of sensors.

To enable the functional attachment to be released from the main unit, the electric connection between the main unit and the functional attachment should be releasable as well. A known solution involves providing an inductive coupling by means of an electric coil in the main unit inductively coupled to an electric coil in the functional attachment. The amount of power that can be transmitted via such a type of electric connection is however limited. Another known solution involves providing a mechanical coupling by means of electrical contact elements on the main unit and in the functional attachment. Such a mechanical coupling enables the transmission of relatively high amounts of power. The invention is aimed at creating a possibility of having a releasable electric connection between the main unit and the functional attachment which is capable of transmitting relatively high amounts of power, and which is robust and reliable yet does not involve a notable/significant increase of complexity and/or bulkiness of the design of the main unit and the functional attachment.

### SUMMARY OF THE INVENTION

The invention provides a handheld personal care device comprising a main unit and a functional attachment couplable to and decouplable from the main unit and having a functional personal care unit, wherein:
one of the main unit and the functional attachment comprises a first coupling member having a first coupling axis, a receiving chamber and a metal spring element arranged in the receiving chamber;
the other one of the main unit and the functional attachment comprises a second coupling member having a second coupling axis and a coupling element provided with an engagement surface extending obliquely relative to the second coupling axis;
the first and second coupling members are mutually couplable by aligning the first and second coupling axes and moving the first and second coupling members towards each other along the aligned first and second coupling axes into a coupled condition;
the first and second coupling members are mutually decouplable from the coupled condition by exerting a decoupling force greater than a predefined threshold force on one of the first and second coupling members in an axial direction parallel to the aligned first and second coupling axes and away from the other one of the first and second coupling members;
the receiving chamber is configured and arranged to receive the coupling element in the coupled condition of the first and second coupling members; and
the spring element is configured and arranged to engage with the engagement surface under influence of a spring force of the spring element in said coupled condition of the first and second coupling members to provide a retaining force being substantially the sole force that retains the functional attachment coupled to the main unit in a direction parallel to the axial direction; and wherein further:
said one of the main unit and the functional attachment comprises a first electrical contact element electrically connected to an electrical component of said one of the main unit and the functional attachment;
said other one of the main unit and the functional attachment comprises a second electrical contact element electrically connected to an electrical component of said other one of the main unit and the functional attachment;
in the coupled condition, the first and second electrical contact elements are in mutual contact to provide an electrical connection between the electrical components of the main unit and the functional attachment;
the first electrical contact element comprises the spring element of the first coupling member; and
the second electrical contact element is provided on or comprised by the engagement surface of the second coupling member such that, in the coupled condition of the first and second coupling members, the second electrical contact element is in contact with the spring element under the influence of the spring force of the spring element.

It follows from the above definition of the handheld personal care device according to the invention that the device is designed in such a way that a releasable electric connection is enabled, wherein use is made of electrical contact elements. Practical examples of the electrical component of the main unit include an electrical power source and an electronic processor. Practical examples of the electrical component in the functional attachment include a motor, an actuator, a light source, a heat source, a sensor and a detector. The electric connection can thus be used for transfer of electric power from the main unit to the functional attachment, or for electronic data transmission between the main unit and the functional attachment, or for both such electric power transfer and such electronic data transmission.

In the context of the invention, the releasable electric connection is compatible with the mechanical coupling interface between the main unit and the functional personal care unit, which comprises first and second coupling members, the first coupling member comprising a receiving chamber and a metal spring element arranged in the receiving chamber, and the second coupling member comprising a coupling element provided with an engagement surface extending obliquely relative to the second coupling axis. The releasable electric connection uses the metal spring element of the coupling interface as a first electrical contact element, while the engagement surface of the coupling interface is provided with or comprises a second electrical contact element. When the functional personal care unit is coupled to the main unit, the second electrical contact element is in electric contact with the spring element, i.e. with the first electrical contact element. The electric contact between the first and second electrical contact elements is of a firm nature as a result of the spring force exerted by the spring element on the obliquely oriented engagement surface. In view of the fact that in the device according to the invention, the spring force of the spring element is substantially the sole force that retains the functional attachment coupled to the main unit in a direction parallel to the axial direction, the spring force should be sufficiently high to maintain the functional attachment coupled to the main unit under normal use conditions. This inherently provides the firm electrical contact between the first and second electrical contact elements.

A first notable advantage of the invention resides in the fact that, for the purpose of realizing the releasable electric connection in the handheld personal care device as desired, clever use is made of the way in which the mechanical coupling interface of the main unit and the functional personal care unit of the device is designed, without hampering the mechanical coupling interface and without a need to take complex constructional measures. The number of additional components, i.e. the number of components added to the existing mechanical coupling, is kept to a minimum, and the level of compactness can be high. Further, as already mentioned in the foregoing, due to the use of the spring element, it is achieved that the electric contact between the first and second electrical contact elements is of a firm nature. A second notable advantage of the invention resides in the fact that, when the functional attachment is being coupled to or being decoupled from the main unit, the spring element slides over the second electrical contact element, so that any contaminations on the surfaces of the electrical contact elements which might hinder electric transmission between the electrical contact elements are scraped off the very moment contact between the electrical contact elements is established or interrupted. In this respect, it is noted that such contaminations may result from pollution or corrosion, especially in case the personal care device is suitable and intended to be used under wet conditions such as under the shower.

In a practical embodiment of the handheld personal care device according to the invention, the second electrical contact element is arranged in a notch provided in the engagement surface. In that way, it is achieved that the second electrical contact element is well supported by the coupling element of the second coupling member. Further, it is advantageous if a contact surface of the second electrical contact element is substantially flush with the engagement surface, so that the spring element can slide over and bear against a smooth surface that is free from irregularities, and the spring element can be in substantially equally firm engagement with both the second electrical contact element and the remaining portion of the engagement surface.

Both the spring element and the second electrical contact element may be of elongate design. In this respect, it may be practical if the spring element has a main direction of extension in an imaginary plane perpendicular to the first coupling axis, and the second electrical contact element has a main direction of extension in an imaginary plane comprising the second coupling axis. Having such design and orientation of the spring element and the second electrical contact element contributes to both ease and reliability of establishing the releasable electric connection in the handheld personal care device as desired, which does not alter the fact that other possibilities in respect of the design and orientation of the spring element and the second electrical contact element are covered by the invention as well.

It is practical if the coupling element is shaft-like and the engagement surface is provided in a recess provided in a circumferential surface of the coupling element. Advantageously, the shape and the size of the recess are chosen so that the spring element fits well in the recess and can be received in the recess and released from the recess in sliding fashion.

The invention covers a double version of the combination of the releasable mechanical coupling and the releasable electric connection, i.e. a version in which:
the second coupling member comprises a pair of engagement surfaces arranged in opposite positions on the coupling element relative to the second coupling axis;
a pair of second electrical contact elements is respectively provided on or comprised by the pair of engagement surfaces; and
the first coupling member comprises a pair of spring elements arranged to respectively be in contact with the pair of second electrical contact elements in the coupled condition of the first and second coupling members.

According to one practical option, the handheld personal care device is an electric shaver, the functional attachment is a shaving unit comprising at least one hair-cutting unit, and the main unit accommodates a motor configured to drive the at least one hair-cutting unit in the coupled condition of the first and second coupling members. Other options are feasible as well. The invention relates to any type of handheld personal care device comprising a main unit and a functional attachment couplable to and decouplable from the main unit in which a releasable electric connection between an electrical component of the main unit and an electrical component of the functional attachment needs to be established. Well-known examples are electric toothbrushes and skin care devices.

When the handheld personal care device is an electric shaver as suggested here before, it may particularly be so that:
the shaving unit comprises at least two hair-cutting units;
the main unit comprises the first coupling member, i.e. the coupling member comprising the receiving chamber and the metal spring element, and the shaving unit comprises the second coupling member, i.e. the coupling member comprising the coupling element provided with the obliquely oriented engagement surface;
the coupling element of the second coupling member accommodates a central drive shaft of the shaving unit which, in the coupled condition of the first and second coupling members, is coupled to the motor in the main unit; and
the shaving unit comprises a transmission unit to transmit a rotation of the central drive shaft to each of the hair-cutting units to drive the hair-cutting units.

The above-described and other aspects of the invention will be apparent from and elucidated with reference to the following detailed description of components involved in a releasable electric connection in an electric shaver comprising a main body and a shaving unit couplable to and decouplable from the main body.

### BRIEF DESCRIPTION OF THE DRAWINGS

The invention will now be explained in greater detail with reference to the figures, in which equal or similar parts are indicated by the same reference signs, and in which:

FIG. 1 diagrammatically shows an electric shaver as a practical example of a handheld personal care device according to the invention, comprising a main body and a shaving unit;

FIGS. 2 and 3 diagrammatically show parts of the main unit and the shaving unit in a coupled state of the electric shaver, wherein FIG. 3 shows the parts with a portion thereof cut away;

FIG. 4 illustrates in sectional view how one of two metal spring elements of the main unit contacts one of two electrical contact elements of the shaving unit in the coupled state of the electric shaver;

FIG. 5 diagrammatically shows an entirety of one of the two electrical contact elements of the shaving unit and an electrically conductive extension strip;

FIG. 6 illustrates how the electrical contact element of the shaving unit is arranged at an engagement surface of a coupling element of the shaving unit;

FIG. 7 diagrammatically shows a portion of the shaving unit, including the two electrical contact elements and the coupling element; and

FIG. 8 shows a detail of FIG. 7.

### DETAILED DESCRIPTION OF THE EMBODIMENTS

The invention relates to a handheld personal care device comprising a main unit and a functional attachment couplable to and decouplable from the main unit and having a functional personal care unit. In the following, the invention will be explained in the context of an electric shaver 100 as an example of the handheld personal care device, which does not alter the fact that the invention also covers other types of handheld personal care device. In the electric shaver 100, a main body 10 of the electric shaver 100 is the main unit of the handheld personal care device, and a shaving unit 20 of the electric shaver 100 is the functional attachment of the handheld personal care device.

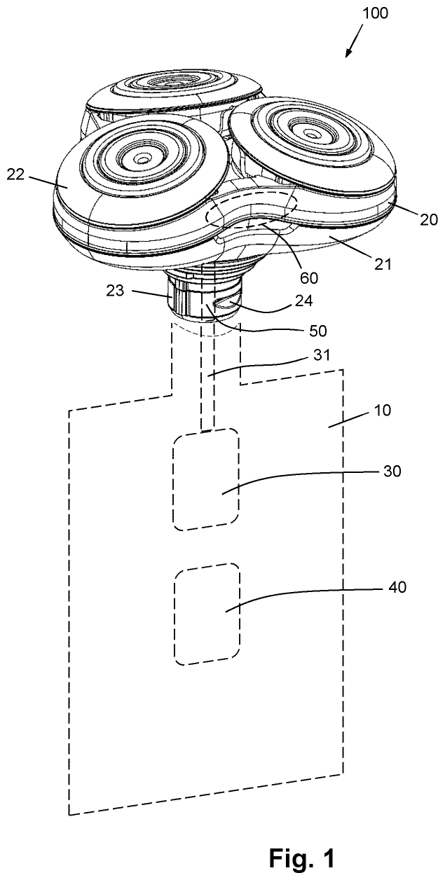

With reference to FIG. 1, it is noted that the shaving unit 20 comprises a supporting member 21 and three hair-cutting units 22 supported by the supporting member 21. In the context of the present example, the number of hair-cutting units 22 can be chosen freely and does not necessarily need to be three, the number being at least one. FIG. 1 illustrates how the shaving unit 20 is combined with the main body 10, the supporting member 21 of the shaving unit 20 being coupled to the main body 10. The main body 10 can be of any suitable design and is only diagrammatically shown by means of dashed lines. For the purpose of performing a shaving action on skin by means of the electric shaver 100, a user of the shaver 100 is supposed to take hold of the main body 10, to place the shaving unit 20 on the skin and to move the shaving unit 20 over the skin. The electric shaver 100 is shown in a normal orientation, which is an orientation in which the shaving unit 20 is positioned on top of the main body 10.

The shaving unit 20 constitutes the part of the shaver 100 by means of which the action of cutting off hairs from the skin can actually be performed, while the main housing 10 has a function in accommodating a motor 30 for driving the components of the shaving unit 20 involved in such action.

The main housing 10 may further include means such as a rechargeable battery 40 for powering the motor 30. The collection of hair-cutting units 22 is part of the functional personal care unit of the shaving unit 20.

The shaving unit 20 and the main housing 10 are releasably connectable to each other, and the shaving unit 20 comprises a shaft-like coupling element 23 accommodating a central drive shaft 50 which is coupled to the motor 30 in a connected condition of the shaving unit 20 to the main body 10.

This option is illustrated in FIG. 1, wherein both the central drive shaft 50 and an output shaft 31 of the motor 30 are indicated through dashed lines. Advantageously, the hair-cutting units 22 of the shaving unit 20 comprise individual drive shafts (not shown), and the shaving unit 20 further comprises a transmission system (not shown) to convert rotation of the central drive shaft 50 into rotation of such individual drive shafts. Such a transmission system may comprise a number of gear wheels, for example.

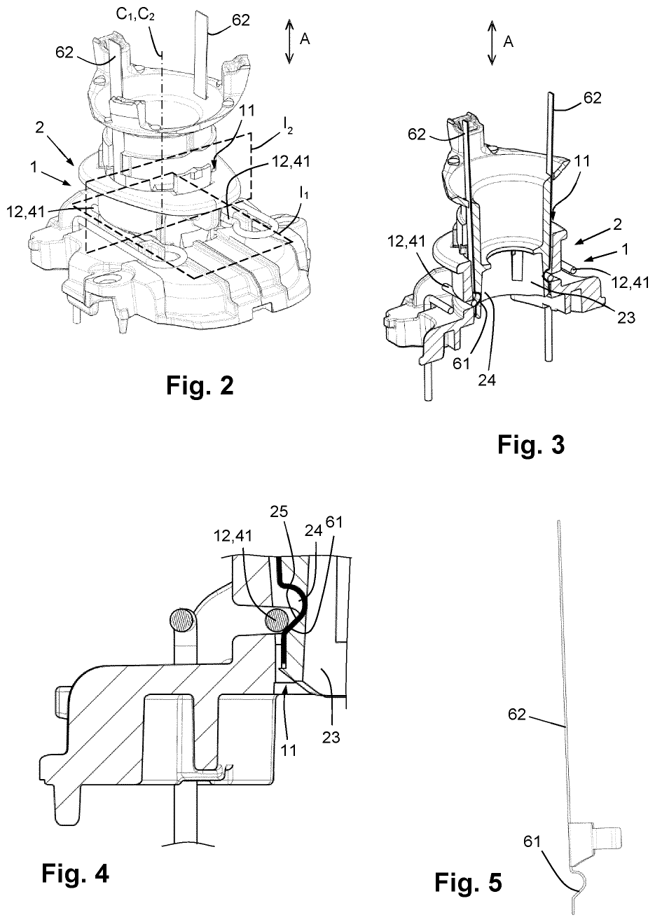

In FIG. 1, it can be seen that the coupling element 23 of the shaving unit 20 is provided with a recess 24 in the circumferential surface thereof. A similar recess 24 is provided at a diametrically opposed position on the coupling element 23, hence, at the side of the coupling element 23 which is not visible in FIG. 1. The recesses 24 in the coupling element 23 are involved in in the releasable mechanical coupling between the main body 10 and the shaving unit 20. In the following, with reference to FIGS. 2-4, details of the releasable mechanical coupling between the main body 10 and the shaving unit 20 will be explained, wherein also details of a releasable electric connection using the geometry in the mechanical interface of the main body 10 and the shaving unit 20 will be explained.

For the purpose of establishing the releasable mechanical coupling, the main body 10 comprises a first coupling member 1 having a first coupling axis C₁, and the shaving unit 20 comprises a second coupling member 2 having a second coupling axis C₂, which second coupling member 200 includes the coupling element 23 mentioned here before. The coupling element 23 is provided with a pair of engagement surfaces 25 arranged in opposite positions on the coupling element 23 relative to the second coupling axis C₂, wherein the engagement surfaces 25 extend obliquely relative to the second coupling axis C₂, and wherein the respective engagement surfaces 25 are provided in the respective recesses 24 mentioned here before. The first coupling member 1 comprises a receiving chamber 11 and a pair of metal spring elements 12 arranged in the receiving chamber 11.

The first and second coupling members 1, 2 are mutually couplable by aligning the first and second coupling axes C₁, C₂ and moving the first and second coupling members 1, 2 towards each other along the aligned first and second coupling axes C₁, C₂ into a coupled condition, wherein the coupling element 23 is received in the receiving chamber 11 and the respective spring elements 12 are received the respective recesses 24, and the first and second coupling members 1, 2 are mutually decouplable from the coupled condition by exerting a decoupling force greater than a predefined threshold force on one of the first and second coupling members 1, 2 in an axial direction A parallel to the aligned first and second coupling axes C₁, C₂ and away from the other one of the first and second coupling members 1, 2, wherein the coupling element 23 is removed from the receiving chamber 11 and the respective spring elements 12 are removed from the respective recesses 24. In the coupled condition of the first and second coupling members 1, 2, each of the spring elements 12 engages with the respective engagement surface 25 under influence of a spring force of the spring element 12. In this way, a retaining force is provided, and this retaining force is substantially the sole force that retains the shaving unit 20 coupled to the main body 10 in a direction parallel to the axial direction A.

The two spring elements 12 are further configured to function as two first electrical contact elements 41 electrically connected to an electrical component of the main body 10 such as the rechargeable battery 40. The shaving unit 20 also comprises an electrical component 60, and is equipped with two second electrical contact elements 61 electrically connected to that electrical component 60. For example, the shaving unit 20 may comprise one or more LEDs and/or may be configured to enable capacitive sensing for skin contact detection. The electric power that is necessary for operating the electrical component 60 in the shaving unit 20 is retrieved from the main body 10 when the electric shaver 100 is in the coupled state and the respective electrical contact elements 41 of the main body 10 in the form of the respective spring elements 12 and the respective electrical contact elements 61 of the shaving unit 20 contact each other. It is to be noted that the electrical component 60 of the shaving unit 20 is only diagrammatically shown in FIG. 1, as an ellipse in dashed lining.

The spring elements 12 in their capacity as first electrical contact elements 41 and the second electrical contact elements 61 of the shaving unit 20 are components of the releasable electric connection mentioned here before, creating two polarities in the electric connection. A notable fact is that the respective second electrical contact elements 61 are located at the position of the respective engagement surfaces 25. In this way, it is achieved that, in the coupled state of the electric shaver 100, the respective second electrical contact elements 61 are in contact with the respective spring elements 12 under the influence of the spring force of the spring elements 12. This implies that there are always high mechanical contact forces as a result of which the electric connection is always reliable and secure. What's more, in the process of the respective spring elements 12 moving to or from their positions in the respective recesses 24, any contamination as may be present on surfaces of the spring elements 12 and/or the second electrical contact elements 61 is automatically scraped off under the influence of the spring-forced contact.

An entirety of one of the second electrical contact elements 61 and an electrically conductive extension strip 62 is shown in FIG. 5. Having an electrically conductive extension strip 62 is one option that is practical when it comes to electrically coupling the second electrical contact elements 61 to one or more components of the shaving unit 20 to be provided with electric power. When the shaving unit 20 is equipped with an entirety of a second electrical contact element 61 and an electrically conductive extension strip 62 or another electrically conductive body, indeed, such entirety may be of an integral nature, in which case manufacturing the entirety may involve providing a metal strip and providing the strip with a bulge for forming the second electrical contact element 61, or may comprise at least two parts which have been joined at some point.

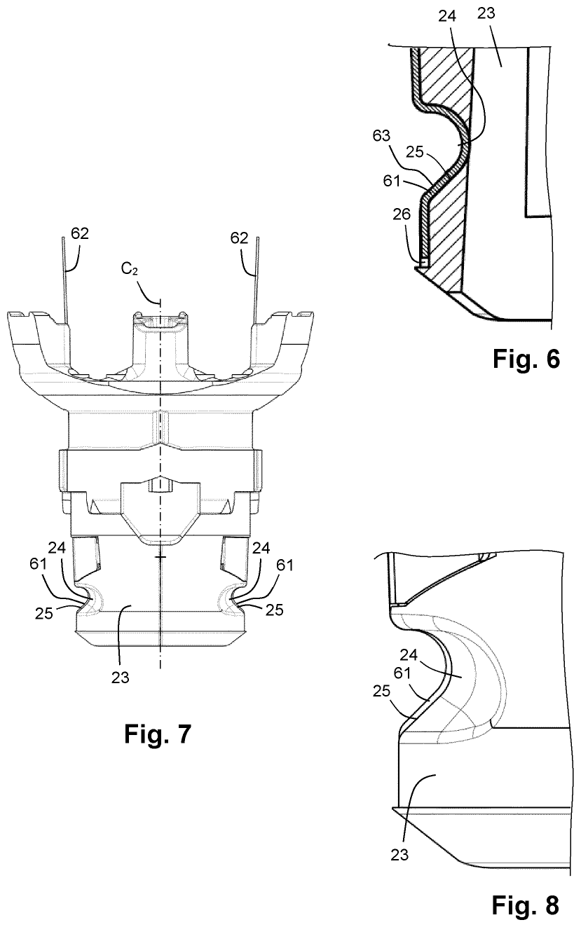

FIG. 6 illustrates the practical option of the second electrical contact element 61 being arranged in a notch 26 provided in the respective engagement surface 25, and also shows that a contact surface 63 of the second electrical contact element 61 is substantially flush with the engagement surface 25. Having only limited dimensions as seen in a direction about the second coupling axis C₂, each of the second electrical contacts 61 is elongate, and so is each of the spring elements 12, albeit in a different direction in the coupled state of the electric shaver 100, namely in a direction in an imaginary plane I₁ substantially perpendicular to the axial direction A, while the second electrical contacts 61 have a main direction of extension in an imaginary plane I₂ substantially perpendicular to the first imaginary plane I₁. The orientation of both imaginary planes I₁, I₂ is illustrated in the perspective view of FIG. 2, in which two dashed rectangles representing portions of the imaginary planes I₁, I₂ are shown.

FIG. 7 clearly shows how the second electrical contact elements 61 are positioned on the coupling element 23. FIG. 8 shows a portion of the coupling element 23 including one of the recesses 24 and one of the second electrical contact elements 61 in enlarged fashion.

A variation to the above-described embodiment of the releasable electric connection is a variation comprising a single spring element 12 and a single second electrical contact element 61. Also in such a case, the advantages following from having a clever combination of a releasable mechanical coupling and a releasable electric connection are obtained, wherein in particular both a function of providing spring force for use in the releasable mechanical coupling and an electrical contact function are performed by one and the same component, namely the metal spring element 12, while the second electrical component 61 is positioned such that a portion thereof is contacted by the spring element 12 when the mechanical coupling is established.

As described here before, the spring elements 12, that form the first electrical contact elements 41 of the first coupling member 1 of the main body 10, are made from metal. In the embodiments described here before, the second electrical contact elements 61 of the second coupling member 2 of the shaving unit 20 are made from a metal strip. Corrosion of the metal spring elements 12 and the second electrical contact elements 61 may lead to an increased electrical contact resistance between the spring elements 12 and the second electrical contact elements 61. To prevent such corrosion, the spring elements 12 and the second electrical contact elements 61 may be made from nickel. In embodiments as described here before, wherein the spring elements 12 are thread-shaped, it may be difficult to manufacture the spring elements 12 purely from nickel. In such embodiment, the spring elements 12 may each have a thread-shaped core element made from a metal other than nickel, such as steel, and the core elements may each be provided, e.g., by means of a chemical deposition method, with a nickel coating having a thickness of at least 25 micrometers. Alternatively, said core element of each of the spring elements 12 may be locally provided with an electrically isolating layer, e.g., made from plastic, and a thin nickel plate may be wrapped around the core element and the isolation layer and double-folded. The position of said nickel plates should be such that each of said nickel plates will electrically contact a respective one of the second electrical contact elements 61 in the coupled condition of the first and second coupling members 1, 2. An electric connection wire, connecting the respective spring element 12 to the electrical component (e.g., the rechargeable battery 40) of the main body 10, may then be soldered to each of said double-folded nickel plates.

It will be clear to a person skilled in the art that the scope of the invention is not limited to the examples discussed in the foregoing, and that several amendments and modifications thereof are possible without deviating from the scope of the invention as defined in the attached claims. It is intended that the invention be construed as including all such amendments and modifications insofar they come within the scope of the claims or the equivalents thereof. While the invention has been illustrated and described in detail in the figures and the description, such illustration and description are to be considered illustrative or exemplary only, and not restrictive. The invention is not limited to the disclosed embodiments. The drawings are schematic, wherein details which are not required for understanding the invention may have been omitted, and not necessarily to scale.

Variations to the disclosed embodiments can be understood and effected by a person skilled in the art in practicing the claimed invention, from a study of the figures, the description and the attached claims. In the claims, the word “comprising” does not exclude other steps or elements, and the indefinite article “a” or “an” does not exclude a plurality. Any reference signs in the claims should not be construed as limiting the scope of the invention.

Elements and aspects discussed for or in relation with a particular embodiment may be suitably combined with elements and aspects of other embodiments, unless explicitly stated otherwise. Thus, the mere fact that certain measures are recited in mutually different dependent claims does not indicate that a combination of these measures cannot be used to advantage.

The terms “comprise” and “include” as used in this text will be understood by a person skilled in the art as covering the term “consist of”. Hence, the term “comprise” or “include” may in respect of an embodiment mean “consist of”, but may in another embodiment mean “contain/have/be equipped with at least the defined species and optionally one or more other species”.

Notable aspects of the invention are summarized as follows. In a handheld personal care device 100 such as an electric shaver, one of a main unit 10 and a functional attachment 20 of the personal care device 100 comprises a first coupling member 1 having a first coupling axis C₁, and a first electrical contact element 41 electrically connected to an electrical component 40 of said one of the main unit 10 and the functional attachment 20, and the other one of the main unit 10 and the functional attachment 20 comprises a second coupling member 2 having a second coupling axis C₂, and a second electrical contact element 61 electrically connected to an electrical component 60 of said other one of the main unit 10 and the functional attachment 20. The first electrical contact element 41 comprises a metal spring element 12 of the first coupling member 1, and the second electrical contact element 61 is provided on or comprised by a surface 25 of the second coupling member 2 which is configured to be engaged by the spring element 12.

1. Handheld personal care device comprising a main unit and a functional attachment couplable to and decouplable from the main unit and having a functional personal care unit, wherein:
one of the main unit and the functional attachment comprises a first coupling member having a first coupling axis, a receiving chamber and a metal spring element arranged in the receiving chamber:
the other one of the main unit and the functional attachment comprises a second coupling member having a second coupling axis and a coupling element provided with an engagement surface extending obliquely relative to the second coupling axis:
the first and second coupling members are mutually couplable by aligning the first and second coupling axes and moving the first and second coupling members towards each other along the aligned first and second coupling axes into a coupled condition:
the first and second coupling members are mutually decouplable from the coupled condition by exerting a decoupling force greater than a predefined threshold force on one of the first and second coupling members in an axial direction parallel to the aligned first and second coupling axes and away from the other one of the first and second coupling members:
the receiving chamber is configured and arranged to receive the coupling element in the coupled condition of the first and second coupling members; and
the spring element is configured and arranged to engage with the engagement surface under influence of a spring force of the spring element in said coupled condition of the first and second coupling members to provide a retaining force being substantially the sole force that retains the functional attachment coupled to the main unit in a direction parallel to the axial direction; characterized in that:
said one of the main unit and the functional attachment comprises a first electrical contact element electrically connected to an electrical component of said one of the main unit and the functional attachment;
said other one of the main unit and the functional attachment comprises a second electrical contact element electrically connected to an electrical component of said other one of the main unit and the functional attachment;
in the coupled condition, the first and second electrical contact elements are in mutual contact to provide an electrical connection between the electrical components of the main unit and the functional attachment;
the first electrical contact element comprises the spring element of the first coupling member; and
the second electrical contact element is provided on or comprised by the engagement surface of the second coupling member such that, in the coupled condition of the first and second coupling members, the second electrical contact element is in contact with the spring element under the influence of the spring force of the spring element.

2. Handheld personal care device as claimed in claim 1, wherein the second electrical contact element is arranged in a notch provided in the engagement surface.

3. Handheld personal care device as claimed in claim 2, wherein a contact surface of the second electrical contact element is substantially flush with the engagement surface.

4. Handheld personal care device as claimed in claim 1, wherein:
the spring element is elongate and has a main direction of extension in an imaginary plane perpendicular to the first coupling axis; and
the second electrical contact element is elongate and has a main direction of extension in an imaginary plane comprising the second coupling axis.

5. Handheld personal care device as claimed in claim 1, wherein the coupling element is shaft-like, and wherein the engagement surface is provided in a recess provided in a circumferential surface of the coupling element.

6. Handheld personal care device as claimed in claim 1, wherein:
the second coupling member comprises a pair of engagement surfaces arranged in opposite positions on the coupling element relative to the second coupling axis:
a pair of second electrical contact elements is respectively provided on or comprised by the pair of engagement surfaces; and
the first coupling member comprises a pair of spring elements arranged to respectively be in contact with the pair of second electrical contact elements in the coupled condition of the first and second coupling members.

7. Handheld personal care device as claimed in claim 1, wherein the electrical component of the main unit comprises an electrical power source or an electronic processor.

8. Handheld personal care device as claimed in claim 1, wherein the electrical component in the functional attachment comprises a motor, an actuator, a light source, a heat source, a sensor or a detector.

9. Handheld personal care device as claimed in claim 1, wherein:
the personal care device is an electric shaver;
the functional attachment is a shaving unit comprising at least one hair-cutting unit; and
the main unit accommodates a motor configured to drive the at least one hair-cutting unit in the coupled condition of the first and second coupling members.

10. Handheld personal care device as claimed in claim 9, wherein:
the shaving unit comprises at least two hair-cutting units;
the main unit comprises the first coupling member and the shaving unit comprises the second coupling member:
the coupling element of the second coupling member accommodates a central drive shaft of the shaving unit which, in the coupled condition of the first and second coupling members, is coupled to the motor in the main unit; and
the shaving unit comprises a transmission unit to transmit a rotation of the central drive shaft to each of the hair-cutting units to drive the hair-cutting units.
